(19) United States
(12) Patent Application Publication
(10) Pub. No.: US 2025/0149626 A1
(43) Pub. Date: May 8, 2025

(54) SODIUM BATTERY

(71) Applicant: TOYOTA JIDOSHA KABUSHIKI KAISHA, Toyota-shi (JP)

(72) Inventors: Hideyuki YAMAMURA, Susono-shi (JP); Hiroshi Suyama, Mishima-shi (JP)

(21) Appl. No.: 18/764,723

(22) Filed: Jul. 5, 2024

(30) Foreign Application Priority Data
Nov. 7, 2023 (JP) 2023-189905

(51) Int. Cl. H01M 10/056; H01M 4/02

(52) U.S. Cl. CPC H01M 10/056; H01M 2004/021

(57) ABSTRACT

The sodium battery of the present disclosure has a cathode layer, a separator, and an anode layer in this order, and is impregnated with an electrolytic solution. The sodium battery of the present disclosure is a sodium metal battery in which sodium metal is deposited during charging, or a sodium ion battery having hard carbon as an anode active material. The separator is composed of a plurality of porous layers, and in the thickness direction of the separator, the pore diameters of the respective layers of the plurality of porous layers are different so as to have two maximum values from the side of the cathode layer toward the side of the anode layer, and the maximum value on the side of the cathode layer among the two maximum values is larger than the maximum value on the side of the anode layer.

### CROSS-REFERENCE TO RELATED APPLICATION

This application claims priority to Japanese Patent Application No. 2023-189905 filed on Nov. 7, 2023, incorporated herein by reference in its entirety.

### BACKGROUND

### 1. Technical Field

The present disclosure relates to a sodium battery.

### 2. Description of Related Art

Lithium-ion batteries are used as power sources for mobile devices and as in-vehicle power supplies, taking advantage of high capacity and lightweight characteristics thereof. On the other hand, in recent years, sodium batteries that use sodium have attracted attention as a material for replacing lithium, from a viewpoint of resource quantities.

For example, Japanese Unexamined Patent Application Publication No. 2017-050148 (JP 2017-050148 A) discloses a sodium-ion battery in which hard carbon is used as an anode.

Now, during charging of a secondary battery, dendrites may be deposited on an anode layer, and growth of the dendrites may result in short-circuiting between a cathode layer and the anode layer. Accordingly, technology for suppressing growth of dendrites has been developed.

For example, Japanese Unexamined Patent Application Publication No. 2022-048597 (JP 2022-048597 A) discloses a secondary battery that is capable of suppressing dendrites, formed on a surface of an anode, from growing beyond a separator.

### SUMMARY

In a sodium battery, there is demand for technology for suppressing growth of dendrites from an anode layer through a separator toward a cathode layer during charging of the battery, thereby suppressing short-circuiting between the cathode layer and the anode layer.

An object of the present disclosure is to provide a sodium battery in which growth of dendrites from the anode layer through the separator toward the cathode layer during charging of the battery is suppressed, whereby short-circuiting between the cathode layer and the anode layer does not readily occur.

The present disclosers found that the above problem can be solved by the following means.

### First Aspect

A sodium battery includes a cathode layer, a separator, and an anode layer. The cathode layer, the separator, and the anode layer are laminated in the order of the cathode layer, the separator, and the anode layer, and impregnated with an electrolytic solution.
The sodium battery is a sodium metal battery in which sodium metal is deposited during charging, or a sodium ion battery including hard carbon as an anode active material, the separator is made up of a plurality of porous layers,
a pore diameter of each layer of the porous layers differs from a side of the cathode layer toward a side of the anode layer in a thickness direction of the separator, such that two maximum values are present, and also,
of the two maximum values, the maximum value on the side of the cathode layer is greater than the maximum value on the side of the anode layer.

### Second Aspect

The sodium battery according to Aspect 1, wherein the maximum value on the side of the cathode layer is no less than 1.1 times and no more than 1.7 times the maximum value on the side of the anode layer.

### Third Aspect

The sodium battery according to Aspect 1 or 2, wherein the maximum value on the side of the cathode layer is no less than 100 nm and no more than 150 nm.

According to the present disclosure, a sodium battery can be provided in which the growth of sodium deposited on the anode layer is suppressed, and short-circuiting between the cathode layer and the anode layer does not readily occur.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional schematic view of a sodium metal battery showing an example of a sodium battery of the present disclosure;

FIG. 2 is a cross-sectional schematic view of a sodium ion battery showing an example of a sodium battery of the present disclosure;

FIG. 3A is a schematic diagram showing the maximum pore size in the separators of the comparative example;

FIG. 3B is a schematic diagram showing the maximum pore size of separators according to an embodiment;

FIG. 4A is a graph showing results of measurement of XPS on an anode layer according to a comparative example;

FIG. 4B illustrating results of measurement of XPS on an anode layer according to an embodiment;

FIG. 5A is a graph showing results of measurement of XPS on the separators of the comparative example; and

FIG. 5B is a graph showing results of measurement of XPS on separators according to an embodiment.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure. In addition, the dimensional relationship (length, width, thickness, and the like) in the drawings does not reflect the actual dimensional relationship.

### Sodium Battery

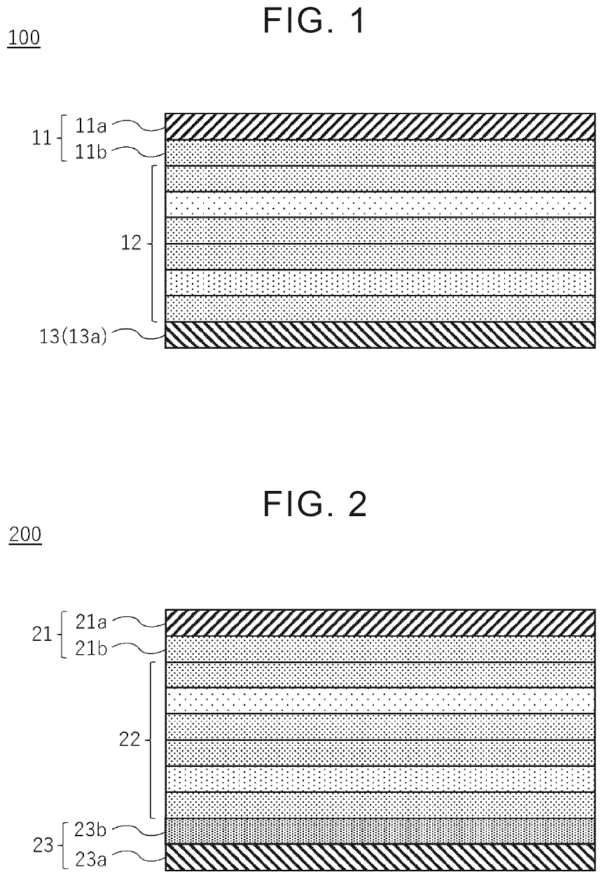

As shown in FIGS. 1 and 2, the sodium batteries 100 and 200 of the present disclosure have cathode layers 11 and 21, separators 12 and 22, and anode layers 13 and 23 in this order, and are impregnated with an electrolytic solution. The sodium battery of the present disclosure is a sodium metal battery 100 in which sodium metal is deposited during charging, or a sodium ion battery 200 having hard carbon as an anode active material. The separators 12 and 22 are composed of a plurality of porous layers. In the thickness direction of the separator, the pore diameters of the respective layers of the plurality of porous layers are different so as to have two maximum values from the side of the cathode layers 11 and 21 toward the side of the anode layers 13 and 23. Among the two maximum values, the maximum value on the side of the cathode layers 11 and 21 is larger than the maximum value on the side of the anode layers 13 and 23.

In a sodium metal battery in which sodium metal is deposited at the time of charging, since the anode potential at the time of charging is equal to or lower than the sodium deposition potential, dendrites easily grow from the anode layer through the separator toward the cathode layer. Similarly, in a sodium ion battery having hard carbon as the anode active material, since the anode potential at the time of charging is close to the sodium deposition potential, dendrites easily grow from the anode layer through the separator toward the cathode layer.

In this regard, the inventors of the present disclosure have unexpectedly found that the growth of dendrites from the anode layer to the cathode layer through the separator can be suppressed by adjusting the pore diameter of the separator constituting the sodium battery. Specifically, this is not intended to be bound by any theory, but is considered as follows. (i) The pore size of each layer in a separator composed of a plurality of porous layers is different so as to have two maximum values. (ii) Among the two maximum values, the maximum value on the cathode layer side is larger than the maximum value on the anode layer side. According to these (i) and (ii), it is considered that the precipitation of sodium in the separator is likely to occur on the cathode layers of the separator. As a result, it is considered that the growth of dendrites from the anode layer to the cathode layer through the separator can be suppressed, and as a result, a short circuit is less likely to occur between the cathode layer and the anode layer.

The sodium battery of the present disclosure has a cathode layer, a separator, and an anode layer in this order, and is impregnated with an electrolytic solution.

In the context of the present disclosure, in the context of the present disclosure, a “cathode layer” means a laminate of a cathode current collector 11a, 21a and a cathode active material layer 11b, 21b. The “anode layer” means an anode current collector 13a or a laminate of an anode current collector 23a and an anode active material layer 23b. In particular, the “anode layer” means an anode current collector 13a in a sodium metal battery, and may mean a laminate of an anode current collector 23a and an anode active material layer 23b in a sodium ion battery. Of the cathode layer and the anode layer, the cathode active material layer and the anode active material layer are disposed on the side of the separator.

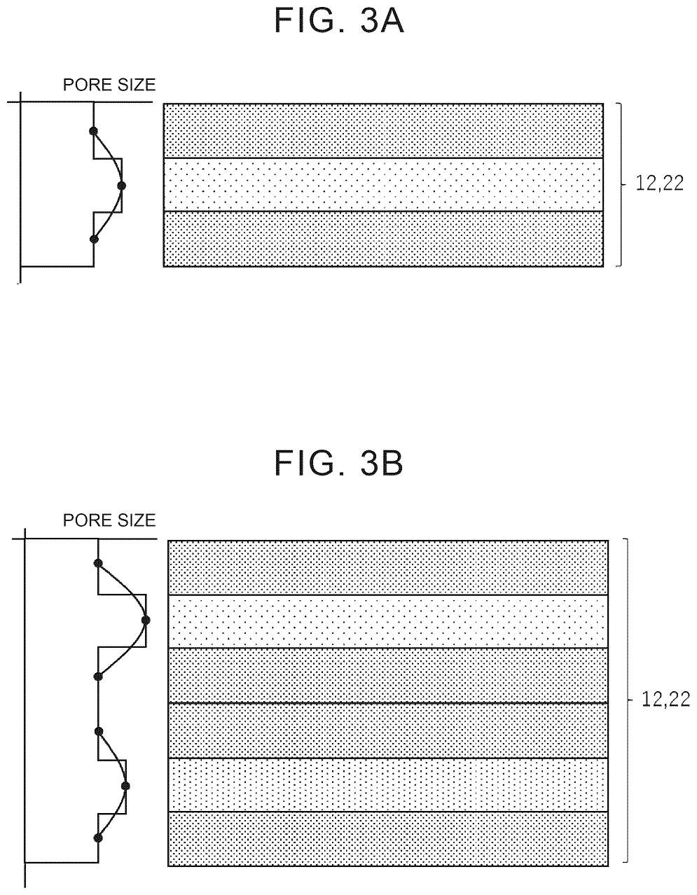

As shown in FIG. 3B, the separators 12, 22 in the disclosed sodium battery are composed of a plurality of porous layers. In the thickness direction of the separators 12 and 22, the pore diameters of the respective layers of the plurality of porous layers are different so as to have two maximum values from the side of the cathode layers 11 and 21 toward the side of the anode layers 13 and 23. Among the two maximum values, the maximum value on the side of the cathode layers 11 and 21 is larger than the maximum value on the side of the anode layers 13 and 23. In contrast, FIG. 3A shows a comparative illustration of the separators 12, 22 having one maximum. In the context of the present disclosure, a maximum value means a value of a pore diameter in a porous layer having a pore diameter larger than that of a porous layer on both adjacent sides in a separator composed of a plurality of porous layers. Note that, in FIG. 3B of the drawings, a separator composed of six porous layers is illustrated, but the numbers of layers of the separator are not limited thereto.

With respect to the pore diameter, the maximum value on the side of the cathode layer may be 1.1 times or more of the maximum value on the side of the anode layer and 1.7 times or less of the maximum value on the side of the anode layer. The maximum value on the side of the cathode layer may be 1.2 times or more, or 1.3 times or more of the maximum value on the side of the anode layer, and may be 1.6 times or less, 1.5 times or less, 1.4 times or less, or 1.3 times or less of the maximum value on the side of the anode layer.

With respect to the pore size, the local maximum of the cathode layers may be 100 nm or more and 150 nm or less. The local maximum of the cathode layers may be greater than or equal to 110 nm, greater than or equal to 120 nm, or greater than or equal to 130 nm, and less than or equal to 140 nm, less than or equal to 130 nm, or less than or equal to 120 nm.

With respect to the pore size, the local maximum of the anode layers may be equal to or greater than 60 nm and equal to or less than 90 nm. The maximum of the anode layers may be greater than or equal to 70 nm or greater than or equal to 80 nm.

The separator in the present disclosure can be obtained, for example, by laminating a plurality of porous layers having different pore diameters such that the pore diameters have two maximum values. As will be described later, the separator in the present disclosure can be obtained, for example, by stacking two PP/PE/PP three-layer separators.

The pore size of the separator can be measured by, for example, mercury intrusion method using a porosimeter. When each layer of the separator in the present disclosure is bonded to each other, each layer of the separator can be peeled off, and the pore diameter of each peeled layer can be measured by the above-described method.

Hereinafter, each layer constituting the battery will be described.

### Cathode Layer

### Cathode Current Collector

Examples of the cathode current collector include SUS, aluminum, nickel, iron, titanium, and carbon. The cathode current collector may have, for example, a foil shape, a mesh shape, or a porous shape.

### Cathode Active Material Layer Including

The cathode active material layer includes a cathode active material, and may optionally include a conductive auxiliary agent and a binder.

Examples of the cathode active material include Na containing oxides such as a layered active material, a spinel-type active material, and an olivine-type active material. Specific examples include NaFeO₂, NaNiO₂, NaCoO₂, NaMnO₂, NaVO₂, Na(Ni_{X}Mn_{1-X})O₂ (0<X<1), Na(Fe_{X}Mn_{1-X})O₂ (0<X<1), NaVPO₄F, and Na₂FePO₄F, Na₃V₂(PO₄)₃. The shape of the cathode active material is not particularly limited. The cathode active material may be in particulate form. Here, the mean particle size may be, for example, greater than or equal to 1 nm or greater than or equal to 10 nm, and may be less than or equal to 100 μm or less than or equal to 30 μm. The larger the content of the cathode active material in the cathode active material layer, the higher the capacity of the cathode. The cathode active material layer may contain, for example, 50% by mass or more, or 70% by mass or more, or 99% by mass or less, or 95% by mass or less of the cathode active material.

The conductive auxiliary agent may be, for example, a carbon material, a metal material, or the like. Specific examples of the carbon material include: carbon black such as acetylene black, Ketjen black, furnace black, and thermal black; carbon fibers such as VGCF; graphite; hard carbon; and coke. Examples of the metallic material include Fe, Cu, Ni, and Al. The content of the conductive auxiliary agent in the cathode active material layer is not particularly limited. For example, the cathode active material layer may contain 1% by mass or more and 50% by mass or less of a conductive auxiliary agent.

The binder may be chemically or electrically stable. Specific examples of the binder include fluorine-based binders such as polyvinylidene fluoride (PVDF)-based binders, polytetrafluoroethylene (PTFE)-based binders, rubber-based binders such as styrene butadiene rubber (SBR)-based binders, olefinic binders such as polypropylene (PP)-based binders, polyethylene (PE)-based binders, cellulose-based binders such as carboxymethyl cellulose (CMC)-based binders, and polyacrylic acid (PAA)-based binders. The content of the binder in the cathode active material layer is not particularly limited, and may be appropriately determined according to the desired binding property.

The cathode active material layer may have a constant thickness. The thickness of the cathode active material layers is not particularly limited, but may be, for example, 0.1 μm or more and 1 mm or less.

### Separator

The material of the separator is not particularly limited as long as it has a function of electrically separating the cathode layer and the anode layer. Examples of the material of the separator include porous sheets made of resins such as polyethylene (PE), polypropylene (PP), polyester, cellulose, and polyamide, porous insulating materials such as nonwoven fabrics such as nonwoven fabrics and glass-fiber nonwoven fabrics, or combinations thereof. The thickness of the separator is not particularly limited, and may be, for example, 5 μm or more and 1 mm or less.

### Anode Layer

### Anode Current Collector

When the sodium battery of the present disclosure is a sodium metal battery, the anode current collector is a sodium metal. In sodium metal batteries, sodium metal precipitates during charging.

When the sodium battery is a sodium-ion battery, the anode current collector may be made of, for example, SUS, aluminum, copper, nickel, carbon, or the like. The anode current collector may have, for example, a foil shape, a mesh shape, or a porous shape.

### Anode Active Material Layer

When the sodium battery of the present disclosure is a sodium ion battery, the anode layer has an anode active material layer. The anode active material layer includes an anode active material, and may optionally include a conductive auxiliary agent and a binder.

The anode active material layer includes hard carbon as the anode active material. The anode active material layer may contain, for example, 50% by mass or more, 70% by mass or more, 99% by mass or less, or 95% by mass or less of hard carbon as the anode active material. The content of the hard carbon relative to the total amount of the anode active material may be 50% by mass or more, 70% by mass or more, 90% by mass or more, 95% by mass or more, or 99% by mass, and may be 100% by mass. That is, the anode active material may be hard carbon. The mean particle size of the hard carbon is not particularly limited, but may be, for example, from 50 nm to 100 μm.

The hard carbon can be produced, for example, by carbonizing a raw material containing a carbon element. The carbonization temperature may be, for example, on the order of 1000 to 2000° C. Carbonization can also be carried out under an inert atmosphere. The raw material of the hard carbon is not particularly limited as long as it is a raw material capable of producing the hard carbon. For example, organic compounds including alcohols such as ethanol, phenols, and aldehydes such as formaldehyde can be used as raw materials. In addition, a resin such as a phenol resin, polyacrylonitrile, or polyimide may be used as a raw material. These raw materials may be used singly or in a mixture of a plurality of types.

For conductive aids and binders, reference can be made to the above description of the cathode layers of the present disclosure.

The anode active material layer may have a constant thickness. The thickness of the anode active material layers is not particularly limited, but may be, for example, 0.1 μm or more and 1 mm or less.

In the case where the sodium battery of the present disclosure is a sodium metal battery, the anode layer does not have to have the anode active material layer.

### Electrolytic Solution

The electrolytic solution may contain a sodium salt and a non-aqueous solvent. Examples of the sodium salt include: inorganic sodium salts such as NaPF₆, NaBF₄, NaClO₄, and NaAsF₆; and organic sodium salts such as NaCF₃SO₃, NaN(CF₃SO₂)₂, NaN(C₂FsSO₂)₂, NaN(FSO₂)₂, and NaC(CF₃SO₂)₃.

The non-aqueous solvent is not particularly limited as long as it dissolves the sodium salt. Examples of the high dielectric constant solvents include: cyclic esters (cyclic carbonates) such as ethylene carbonate (EC), propylene carbonate (PC), and butylene carbonate (BC); γ-butyrolactone, sulfolane; N-methylpyrrolidone (NMP); and 1,3-dimethyl-2-imidazolidinone (DMI). On the other hand, examples of the low-viscosity solvents include: linear esters (linear carbonates) such as dimethyl carbonate (DMC), diethyl carbonate (DEC), and ethyl methyl carbonate (EMC); acetates such as methyl acetate, and ethyl acetate; and ethers such as 2-methyltetrahydrofuran. A mixed solvent in which a high dielectric constant solvent and a low viscosity solvent are mixed may be used.

The electrolytic solution may contain an additive such as fluoroethylene carbonate (FEC).

### Other Configurations

The sodium battery of the present disclosure may include a battery case that houses each layer of the battery, and a terminal connected to a current collector or the like. In addition, the sodium battery of the present disclosure may include a restraining member that restrains each layer along the stacking direction in order to reduce the contact resistance. As for these, the same ones as those in the related art may be used.

Shapes of sodium batteries of the present disclosure may include, for example, coin-type, laminated type, cylindrical type, and square type. The anode active material layer and the cathode active material layer of the sodium battery can be produced, for example, by dry molding such as green compact molding or wet molding using a slurry. The sodium battery may be obtained by laminating the layers constituting the sodium battery to each other and optionally performing a pressing process.

### COMPARATIVE EXAMPLE

### Manufacture of Cells

### Fabrication of Cathode Layer

A cathode active material layer using a sodium-containing layered oxide as a cathode active material was formed on an aluminum (Al) foil as a cathode current collector to prepare a cathode layer.

### Preparation of Separator

As a separator, a separator consisting of the following three porous layers laminated from the cathode side toward the anode side was prepared (PP=polypropylene, PE=polyethylene):

PP (pore diameter: 80 nm)/PE (pore diameter: 90 nm)/PP (pore diameter: 80 nm)

The pore diameter of each layer of the separator was measured by a mercury intrusion method using a porosimeter. Specifically, each layer of the separator was peeled off, and the pore diameters of the peeled layers were measured by the above-described method.

### Preparation of Anode Layer

an anode active material layer using hard carbon as an anode active material was formed on a Al foil as an anode current collector to prepare an anode layer.

### Cell Fabrication

The cathode layer, the separator, and the anode layer were laminated in this order to form a laminate. An electrolytic solution was prepared by adding fluoroethylene carbonate (FEC) 0.1% by mass as an additive to a solution obtained by dissolving 1M sodium hexafluorophosphate (NaPF₆) in ethylene carbonate (EC): diethyl carbonate (DEC)=1:1 (volume ratio). A coin cell of type 2032 of the comparative example was prepared by impregnating the laminate with an electrolytic solution.

In the preparation step of the separator, a coin cell of type 2032 of the example was prepared in the same manner as in the comparative example except that a separator consisting of the following six porous layers laminated from the cathode side toward the anode side was prepared (PP=polypropylene, PE=polyethylene):

PP (PP: 80 nm)/PE (Pore: 120 nm)/PP (Pore: 80 nm)/PP (Pore: 80 nm)/PE (Pore: 90 nm)/PP (Pore: 80 nm)

This separator was obtained by laminating two separators consisting of three layers (PP=polypropylene, PE=polyethylene):

PP (PP: 80 nm)/PE (Pore: 120 nm)/PP (Pore: 80 nm)/PP (Pore: 80 nm)/PE (Pore: 90 nm)/PP (Pore: 80 nm)

### Evaluation

### Confirmation of Degree of Sodium Precipitation

Charging and discharging between 4.2 V to 3.0 V at 0.1 C and at 25° C. were repeated 20 times for the respective cells. Thereafter, the cells were disassembled, and the degree of sodium deposition on the anode layer and on the separators was confirmed by X-ray photoelectron spectroscopy (XPS) and visual inspection.

### Results

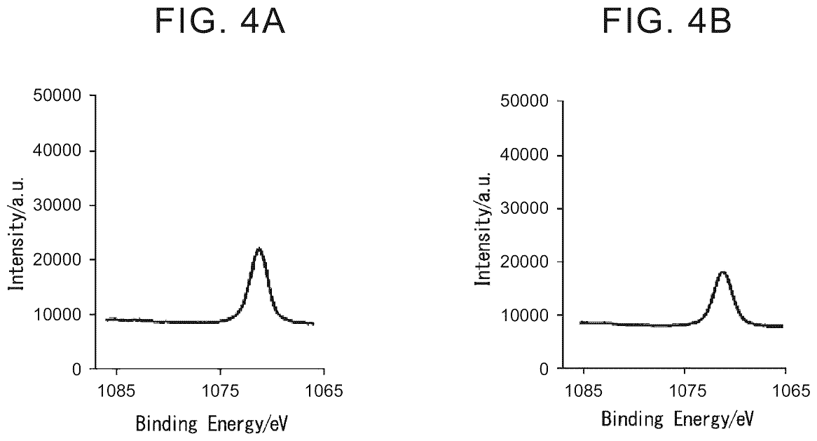

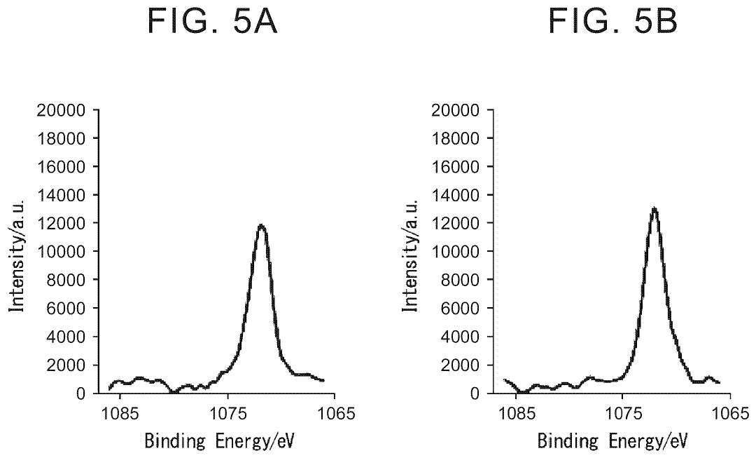

The measurement results of XPS on the anode layers are shown in FIGS. 4A and 4B, and the measurement results of XPS on the separators are shown in FIG. 5. It should be noted that FIGS. 4A and 5A are the results of the comparative examples, and FIGS. 4B and 5B are the results of the examples. As shown in FIGS. 4A and 4B, the strength of the binding energy of sodium on the anode layer was smaller in the cells of the Examples than in the cells of the Comparative Examples. In contrast, as shown in FIGS. 5A and 5B, the strength of the binding energy of sodium on the separators was greater in the cells of the Examples than in the cells of the Comparative Examples. These results suggest that in the cells of the Examples, the precipitation of sodium on the anode layer was suppressed more than in the cells of the Comparative Examples, and more sodium was precipitated on the separators. On the separator, it was also visually confirmed that more sodium was precipitated in the cells of Examples than in the cells of Comparative Examples.

What is claimed is:

1. A sodium battery, comprising:
a cathode layer;
a separator; and
an anode layer, the cathode layer, the separator, and the anode layer being laminated in an order of the cathode layer, the separator, and the anode layer, and impregnated with an electrolytic solution, wherein
the sodium battery is a sodium metal battery in which sodium metal is deposited during charging, or a sodium ion battery including hard carbon as an anode active material,
the separator is made up of a plurality of porous layers,
a pore diameter of each layer of the porous layers differs from a side of the cathode layer toward a side of the anode layer in a thickness direction of the separator, such that two maximum values are present, and also,
of the two maximum values, the maximum value on the side of the cathode layer is greater than the maximum value on the side of the anode layer.

2. The sodium battery according to claim 1, wherein the maximum value on the side of the cathode layer is no less than 1.1 times and no more than 1.7 times the maximum value on the side of the anode layer.

3. The sodium battery according to claim 1, wherein the maximum value on the side of the cathode layer is no less than 100 nm and no more than 150 nm.
